(19) United States
(12) Patent Application Publication
(10) Pub. No.: US 2002/0003779 A1
(43) Pub. Date: Jan. 10, 2002

(54) Method and a system for settign up a call in an internet protocol network

(76) Inventor: Istvan Szabo, Budapest (HU)

Correspondence Address: NIXON & VANDERHYE P.C., 1100 North Glebe Road, 8th Floor, Arlington, VA, 22201-4714, US

(21) Appl. No.: 09/883,369

(22) Filed: Jun. 19, 2001

(30) Foreign Application Priority Data
Jun. 20, 2000 (EP) 00850110.8

(51) Int. Cl. H04L 12/26

(52) U.S. Cl. 370/252; 370/248

(57) ABSTRACT

A method and system for determining whether to accept an incoming telephone call over an Internet Protocol (IP) network. An Internet Protocol (IP) telephony gateway, receiving the incoming call, is given a predetermined threshold condition for at least one performance indicator obtained from a monitoring mechanism for monitoring the performance quality of ongoing calls. The incoming call is accepted if the threshold condition is fulfiled. The predetermined threshold condition may comprise one or more threshold values, wherein a check is made by comparing a current value of the at least one performance indicator value with the one or more threshold values. In this way, a transmission path is ensured with acceptable quality for calls over an IP core network. Call establishment delays are also minimised.

### TECHNICAL FIELD

The present invention relates to a method and system for setting up a connection in an Internet Protocol (IP) network. In particular, the present invention is concerned with accepting or rejecting an incoming call which is to be transmitted over an IP network.

### BACKGROUND OF THE INVENTION AND PRIOR ART

Today, there is a demand for services offering real time traffic over an Internet Protocol (IP) network. For example, when establishing a voice call connection using IP telephony, users demand real time traffic with a minimum of transmission delays. In order to meet this demand, a transport protocol called RTP (Real Time Protocol) has been developed for carrying real time traffic over an IP network. The RTP is described in H. Schulzrinne et al.: ″RTP: A Transport Protocol for Real-Time Applications, RFC 1889, January, 1996. The paper by H. H. Schulzrinne also describes a mechanism termed RTCP which is used for extracting statistics about RTP sessions. The RTCP mechanism can collect and output information regarding call statistics such as delay, jitter and packet-loss ratio. Thus, it is possible to obtain statistics relating to the quality of the call for each individual call.

Recently, it has been proposed to extend the RTP to enable the multiplexing of low bit-rate compressed voice streams from different sources into a single RTP packet. When setting up a call over an IP network, the following procedure will be performed. First, a call is initiated from a calling subscriber over an Access Network (AN). The Access Network is connected to an IP telephony gateway which communicates with other IP telephony gateways over an IP core network.

When receiving packets from several subscribers, the IP telephony gateway may multiplex packets from multiple sources if the received packets are destined to the same remote Access Network. The packets are thus multiplexed into a single RTP/UDP(User Datagram Protocol)/IP (Internet Protocol) packet.

Furthermore, there exists other ways of multiplexing Internet Protocol telephony calls. For example, a method is described in B. Thompson et al. “Tunnelling Multiplexed Compressed RTP”, Internet Draft, March 2000, Work in Progress, wherein a multitude of RTP/UDP/IP packets are compressed and multiplexed into a so-called PPP packet before being transmitted over an IP core network.

When a call establishment message is received by an IP telephony gateway, it is important to ensure that a high quality transmission path is available over the IP core network to a remote IP telephony gateway which is connected to a remote Access Network to which the call is destined.

If the IP telephony gateway is capable of ensuring a transmission path with acceptable transmission quality, the call is accepted and the call establishment is allowed to proceed. Otherwise, if the transmission path is deemed not to have an acceptable transmission quality, the call is rejected. The gateway then typically returns a negative acknowledgement.

In order to ensure a transmission path with acceptable transmission quality, a number of methods have previously been proposed:

1. An IP telephony gateway which is implemented in accordance with the IETF intserv framework, see R.Braden et al.:

“Resource Reservation Protocol (RSVP)”, RFC 2202, September, 1997, and J. Wroclawski: “The Use of RSVP with Integrated Services”, RFC 2210, September, 1997, operates as follows: Upon arrival of a call establishment message, the IP telephony gateway issues a resource reservation message travelling through the IP core network. Thus, each router along the transmission path examines the request and reserves the necessary transmission resources. If the resource reservation is successful, the IP telephony gateway receives an acknowledgement and the call establishment may proceed towards the remote IP telephony gateway.

2. An IP telephony gateway may assume that the IP core network is over-dimensioned and may thus admit all received calls without making an effort to ensure a high quality transmission path.

3. An IP telephony gateway, having a load control method implemented according to L. Westberg, Z. R. Turanyi, “Load Control of Real-Time Traffic”, Internet draft, June, 1999, would operate as follows: An IP telephony gateway receiving a call may send a probe packet over the IP core network to a remote IP telephony gateway. Each router in the IP core network continuously maintains information about the current traffic load. When a router being congested receives the probe packet, the packet is marked accordingly by the router. The remote IP telephony gateway encapsulates the header of the marked probe packet into the payload of a new probe packet. The new probe packet is then transmitted back to the IP telephony gateway that has initiated the original probe packet. When the initiating IP telephony gateway receives the new probe packet, it may be determined whether the IP core network is congested, based on the information in the new probe packet. If it is determined that the IP core network is congested, the call receiving IP telephony gateway rejects the call. If not, the call is accepted and establishment of the call may proceed accordingly.

4. In EP 0999674, it is described that a quality of service can be guaranteed for an incoming call by checking a remaining available transmission capacity over an identified IP network path for the incoming call. Bandwidth capacity data for each path segment within the IP network is maintained by a Virtual Provisioning Server, which is forwarded to a Signaling Gateway for determining whether to accept the incoming call.

However, the earlier proposed methods for ensuring a transmission path with acceptable quality are associated with certain drawbacks. Thus, method 1 requires that per-flow states are installed in each router. Furthermore, the time it takes for transmitting resource reservation messages through the IP core network will significantly delay the establishment of calls. Method 2 is only valid when it can be guarantied that the core network is over-dimensioned. Otherwise, the performance of the network will be significantly reduced. Method 3 will result in considerable delays of call establishments, since sending probe packets in each direction takes some time. Also, each router must be provided with the required software in order to handle probe packets properly. Also in method 4, it takes some time and signaling to perform the transmission capacity check, resulting in unwanted delays.

### SUMMARY

It is an object of the present invention to overcome the problems outlined above by providing a method and system for ensuring a transmission path with acceptable quality over an Internet Protocol (UP) core network. Another object is to minimised call establishment delays, yet providing a reliable transmission path. Furthermore, it is an object to provide a method and system for setting up a call connection which is inexpensive to implement in an IP core network.

This object and others are obtained by a method and a system wherein the Internet Protocol (IP) telephony gateway is given a predetermined threshold condition for at least one performance indicator obtained from a monitoring mechanism. As incoming call is only accepted if the threshold condition is fulfiled. The predetermined threshold condition may comprise one or more threshold values, wherein a check is made by comparing a current value of the at least one performance indicator values with the one or more threshold values. For example, an incoming call may be accepted if a present performance indicator value is below or above a predetermined threshold value. Alternatively, a function of one or several performance indicating values may be formed and used for accepting or rejecting incoming calls.

In particular, the IP telephony gateway collects statistics for a number of ongoing calls for determining whether to accept an incoming call, based on the collected statistics. For example, an average value of at least one quality indicating performance parameter for a number of ongoing calls may be calculated.

Thus, by monitoring the quality of ongoing calls, the IP telephony gateway can determine whether to accept a new incoming call or not. In particular, the method for monitoring ongoing calls may be the well-known RTCP mechanism, which is often already implemented in existing IP telephony gateways.

In that case, no new mechanism for monitoring the ongoing calls is required. However, if another mechanism for monitoring ongoing calls is used in some applications, this mechanism may of course be used instead or as a supplement.

The additional logic required for performing the inventive procedure is preferably obtained by implementing a computer program, making it possible to easily change threshold values or other parameters which are used in the determination process.

### BRIEF DESCRIPTION OF THE DRAWINGS

The present invention will now be described in more detail and with reference to the accompanying drawings, in which:

FIG. 1 is a general view of an Internet telephony network in which the invention may be implemented, and

FIG. 2 is a flowchart illustrating different steps carried out when accepting or rejecting an incoming call in an IP telephony gateway according to the invention.

### DESCRIPTION OF PREFERRED EMBODIMENTS

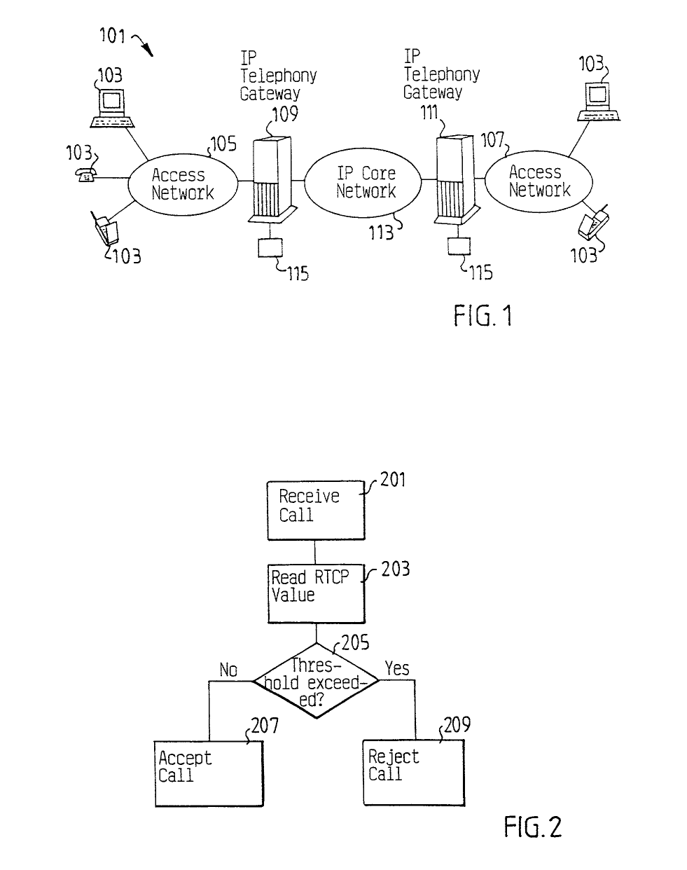

In FIG. 1, a general view of an exemplary Internet telephony network 101 is shown in which the present invention may be implemented. The network 101 generally comprises a plurality of subscribers 103 being connected to various Access Networks. In FIG. 1, a first Access Network 105 and a second Access Network 107 are shown. Each Access Network is connected to an IP telephony gateway in order to provide communication over an Internet Protocol (IP) core network 113. In the example shown in FIG. 1, the first Access Network 105 is connected to a first IP telephony gateway 109, and the second Access Network 107 is connected to a second IP telephony gateway 111. The IP telephony gateways 109 and 111 are interconnected by the IP core network 113. Furthermore, each of the IP telephony gateways 109 and 111 has access to a monitoring mechanism for monitoring the performance quality of ongoing calls, e.g., the RTCP mechanism, as indicated by the reference numeral 115. Each IP telephony gateway 109, 111 may thereby read present values of one or more performance indicators from the monitoring mechanism 115.

FIG. 2 is a flowchart illustrating different steps performed in an IP telephony gateway, with further reference to FIG. 1, when accepting or rejecting an incoming call. Thus, when a call is to be established between a first subscriber 103 connected to the first Access Network 105 and a second subscriber 103 connected to the second Access Network 107, the following steps are performed.

First, in a step 201, an incoming call from the first subscriber 103 to the second subscriber 103 is received by the IP telephony gateway 109. Thereupon in a step 203, the current value of at least one performance indicator is read from the monitoring mechanism 115, e.g., the RTCP mechanism. In particular, the IP telephony gateway 109 collects statistics from a number of ongoing calls for determining whether to accept or reject an incoming call, based on the collected statistics. The at least one performance indicator value is then obtained from the collected call statistics. For example, an average value of at least one quality indicating performance parameter for a number of ongoing calls may be calculated.

Next in a step 205, it is checked if the at least one current performance indicator value, which is read from the monitoring mechanism 115, fulfils a threshold condition. This may be done by comparing the performance indicator value with a pre-set threshold value, e.g., by checking if the performance indicator value is above or below the pre-set threshold value. If plural performance indicators are used, the threshold condition may be that all values or any predetermined number thereof should be above or below respective pre-set threshold values. Alternatively, a function of one or several performance indicator values may be formed, wherein it is checked if the formed function fulfils a threshold condition.

If it is determined in step 205 that the threshold condition is fulfiled, e.g., that the at least one performance indicator value read from the RTCP mechanism does not exceed a pre-set threshold value, the call is accepted in a step 207. The call establishment procedure is then allowed to proceed according to normal routines. On the other hand, if it is determined in step 205 that the threshold condition is not fulfiled, e.g., that at least one performance indicator value exceeds a pre-set threshold value, the IP telephony gateway rejects the call in a step 209. A negative acknowledgement message may then be transmitted back to the subscriber 103 who has initiated the call.

In particular, the IP telephony gateway may in step 203 read performance indicator values from the RTCP mechanism such as the “FRACTION_LOST” and “INTERARRIVAL JITTER” values, the values being indicative of the performance quality of ongoing calls. The FRACTION_LOST value indicates the amount of packets lost between two subsequent reports. The INTERARRIVAL JITTER value indicates the mean deviation in the difference of packet spacing at the receiver compared to the packet spacing at the sender. These two values are typically reported on a regular basis in the RTCP mechanism.

The method described above may advantageously be implemented in an IETF diffserv environment, see S. Blake et al. “.An Architecture for Differentiated Services” RFC 2475, December 1998. Voice traffic is preferably transmitted using a service ensuring that each packet is either lost or transmitted through the network with a minimum of delay, for example using Expedited Forwarding. During a start-up phase, when no information is available, all incoming calls may be accepted.

Further, a round trip delay may also be estimated by using the RTCP mechanism. Thus, the method is applicable in a “best effort” type of network for providing a performance guaranty for telephone calls. However in such a case, statistics regarding not only packet loss, but also regarding packet delay, should be collected from the network.

Thus, the IP telephony gateway can determine whether to accept a new incoming call or not by monitoring the quality of ongoing calls. In particular, the method for monitoring ongoing calls may be the well-known RTCP mechanism, which is often already implemented in existing IP telephony gateways. In that case, no new mechanism for monitoring the ongoing calls is necessary. However, if another mechanism for monitoring ongoing calls is used in some applications, this mechanism may of course be used instead or as a supplement.

The IP telephony gateway is thus given a threshold condition for at least one performance indicator of the RTCP mechanism, and accepts an incoming call only if the threshold condition is fulfiled. For example, an incoming call may be accepted if the present value of the at least one performance indicator is below or above a predetermined threshold value.

Any predetermined combination of performance indicator values and pre-set threshold values may be used as a threshold condition when plural performance indicators are used. Alternatively, a function of one or several performance Indicating values may be formed and used for accepting or rejecting incoming calls.

By using the method and system as described herein for determining whether to accept or reject an incoming call in an IP telephony gateway, a very cost efficient determination mechanism is obtained. Furthermore, the mechanism is robust and reliable, also providing an accept or reject decision very fast compared to existing mechanisms.

1. A method of determining whether to accept an incoming Internet Protocol (IP) telephone call over an Internet Protocol (IP) network, the method comprising the steps of:
A) receiving an incoming call,
B) reading at least one current performance indicator value provided by a monitoring mechanism for monitoring the performance quality of ongoing calls, and
C) determining if the incoming call is to be accepted or rejected based on the read at least one performance indicator value.

2. A method according to claim 1, wherein the monitoring mechanism is an RTCP mechanism.

3. A method according to claim 1, wherein the read at least one performance indicator value is obtained from statistics collected from a plurality of ongoing calls.

4. A method according to claim 1, wherein the at least one performance indicator value indicates any of a number of lost packets and a difference between packet spacing at the receiver and packet spacing at the sender.

5. A method according to claim 1, wherein the determining step C) is performed by checking if the read at least one performance indicator value fulfils a predetermined threshold condition.

6. A method according to claim 5, wherein the threshold condition comprises at least one threshold value, and that the determining step C) is performed by comparing the read at least one performance indicator value with the at least one threshold value.

7. A method according to claim 5, wherein a function of at least one read performance indicator value is formed and that the determining step C) is performed by checking if the formed function fulfils the threshold condition.

8. A system for determining whether to accept an incoming Internet Protocol (IP) telephone call in an IP telephony gateway for transmission over an Internet Protocol (IP) network, the system comprising:
means for receiving an incoming call,
means for reading at least one current performance indicator value provided by a monitoring mechanism for monitoring the performance quality of ongoing calls, and
means for determining if the incoming call is to be accepted or rejected based on the read at least one performance indicator value.

9. A system according to claim 8, wherein the monitoring mechanism is an RTCP mechanism.

10. A system according to claim 8, wherein the read at least one performance indicator value is obtained from statistics collected from a plurality of ongoing calls.

11. A system according to claim 8, wherein the at least one performance indicator value indicates any of a number of lost packets and a difference between packet spacing at the receiver and packet spacing at the sender.

12. A system according to claim 8, the system further comprising means for checking if the read at least one performance indicator value fulfils a predetermined threshold condition.

13. A system according to claim 12, wherein the threshold condition comprises at least one threshold value, and that the system further comprises means for comparing the read at least one performance indicator value with the at least one threshold value.

14. A system according to claim 12, the system further comprising:
means for forming a function of at least one read performance indicator value, and
means for checking if the formed function fulfils the threshold condition.

15. A computer program for determining whether to accept an incoming Internet Protocol (IP) telephone call over an Internet Protocol (IP) network, wherein the computer program, when run on a computer, executes the steps of:
determining if the incoming call is to be accepted based on at least one current performance indicator value provided by a monitoring mechanism for monitoring the performance quality of ongoing calls, and
output a signal indicating the result of said determining step.

16. A computer program according to claim 15, wherein the monitoring mechanism is an RTCP mechanism.

17. A computer program according to claim 15, wherein the at least one current performance indicator value is obtained from statistics collected from a plurality of ongoing calls.

18. A computer program according to claim 15, wherein the at least one current performance indicator value indicates any of a number of lost packets and a difference between packet spacing at the receiver and packet spacing at the sender.

19. A computer program according to claim 15, wherein the detemining step is executed by checking if the read at least one performance indicator value fulfils a predetermined threshold condition.

20. A computer program according to claim 19, wherein the threshold condition comprises at least one threshold value, and that the detemining step is executed by comparing the read at least one performance indicator value with the at least one threshold value.

21. A computer program according to claim 19, wherein a function of at least one read performance indicator value is formed and that the detemining step is executed by checking if the formed function fulfils the threshold condition.
